(19) United States
(12) Patent Application Publication
(10) Pub. No.: US 2012/0051776 A1
(43) Pub. Date: Mar. 1, 2012

(54) METHOD AND SYSTEM FOR ADJUSTING PRINT PRICING ON SELECTIVELY VARYING OPERATING SPEED

(75) Inventor: DAVID A. THOMAS, Buckinghamshire (GB)

(73) Assignee: XEROX CORPORATION, NORWALK, CT (US)

(21) Appl. No.: 12/874,197

(22) Filed: Sep. 1, 2010

(51) Int. Cl. G03G 15/00; G03G 21/00; G03G 21/02

(52) U.S. Cl. 399/75; 399/79

(57) ABSTRACT

The present disclosure provides systems and methods for selectively varying the operating speed of an image-forming apparatus. The method includes selecting an identifier specifying a desired operating speed for executing a job on the image-forming apparatus. The method includes configuring the image-forming apparatus with the desired operating speed upon verification of authorization information received along with the identifier. In case the identifier does not specify a desired operating speed, the method includes identifying an appropriate operating speed of the image-forming device for executing the job and configuring the image-forming apparatus with the identified operating speed. Once the image-forming apparatus is configured with the desired or appropriate operating speed, the job is executed with the set configuration.

### TECHNICAL FIELD

The presently disclosed embodiments relate to digital printing apparatus, such as xerographic or ink-jet printers, and more particularly to selectively varying the configuration of the digital printing apparatus.

### BACKGROUND

In an office-equipment environment, such as for printers and copiers, a common business model employs a single large machine, with separate software controls allowing individual users to operate the machine. Typically an external vendor provides this machine, and users pay the vendor based on usage often measured by per-print, per-use, or “click” charges.

Different users operate the machine at different usage rates, and they have different use requirements. Some users require general office use, such as printing and emails, involving small-size documents that may not require high-speed printing. Even in those environments, however, a certain critical and high-volume jobs may require high-speed printing options. Typically, general office use requires a performance rate of about 30 to 40 pages per minute, for production purposes the operating speed of about 70 to 90 pages per minute may be preferred, however.

Conventionally, a user having varying operating speed requirement should employ different machines for different use requirements. Unless one works in an environment including numbers of different machines, however, that solution simply is not practical. Certain existing solutions allow operating speed variation of a single machine based on a number of parameters, such as type of job submitted or the type of media sheet used. A marked drawback of such systems, though, is their general inability to charge different use rates for different speeds. Depending on the particular setting, either the user is overpaying at slower speeds, or the owner is under-collecting at higher speeds.

It would be highly desirable to have a simple and cost-effective system for selectively varying the operating speed of an image-forming apparatus.

### SUMMARY

One embodiment of the present disclosure provides method for selectively varying the operating speed of an image-forming apparatus. The method includes selecting an identifier associated with a job for execution on the image-forming apparatus. Upon a determination that the identifier specifies a desired operating speed of the image-forming apparatus, the method includes accepting authorization information and configuring the image-forming apparatus with the desired operating speed upon verification of the authorization information. In case the identifier does not specify a desired operating speed, the method includes identifying an appropriate operating speed of the image-forming device for executing the job and configuring the image-forming apparatus with the identified operating speed. Once the image-forming apparatus is configured with the desired or appropriate operating speed, the job is executed with the set configuration.

Another embodiment discloses a system for selectively varying the operating speed of an image-forming apparatus. The system includes an interface module configured to receive a job and an associated identifier for execution on the image-forming apparatus. A controller, operatively coupled to the interface module, is configured to modify the operating speed of the image-forming apparatus. The controller identifies a desired operating speed associated with the identifier and verifies authorization information received along with the identifier. Alternatively, the controller automatically determines an appropriate operating speed of the image-forming apparatus. Subsequently, the controller executes the job with the set operating speed.

### BRIEF DESCRIPTION OF THE DRAWINGS

FIG. 1 illustrates an exemplary embodiment of a digital copier-printing apparatus.

FIG. 2 is a diagram illustrating an exemplary operating speed varying system.

FIG. 3 is a flowchart of an exemplary method for selectively varying the operating speed of the digital copier-printer shown in FIG. 1.

### DETAILED DESCRIPTION

The following detailed description is made with reference to the figures. Preferred embodiments are described to illustrate the disclosure, not to limit its scope, which is defined by the claims. Those of ordinary skill in the art will recognize a number of equivalent variations in the description that follows.

### Overview

The present disclosure describes various embodiments of a system and a method for varying the operating speed of an image-forming device. The disclosed method provides a mechanism to vary the operating speed of each printing job. The speed variation in turn adjusts the pricing structure associated with the job. The term “job” as used here refers to a task of printing, copying, scanning, or any other known job that may be performed on a typical digital copier-printer device. In general, a user is provided with an option to choose between a high or low operating speed. Alternatively, a set of possible operating speeds may be presented to a user while submitting the job. Based on the operating speed selected, the method varies the frequency of the motor coupled to the printer, thus varying the operating speed. Further, the method also provides capabilities of monitoring a set of parameters associated with a particular printer and the jobs submitted to the printer to determine an appropriate operating speed automatically at any point in time. The price associated with each job submitted by a user is computed based on the billing rate associated with the selected operating speed. By varying the operating speed, the user is able to adjust the associated billing amount at any point in time. As a result, the present disclosure presents an option that allows a user to achieve fast job execution by paying a higher amount.

### Exemplary Embodiments

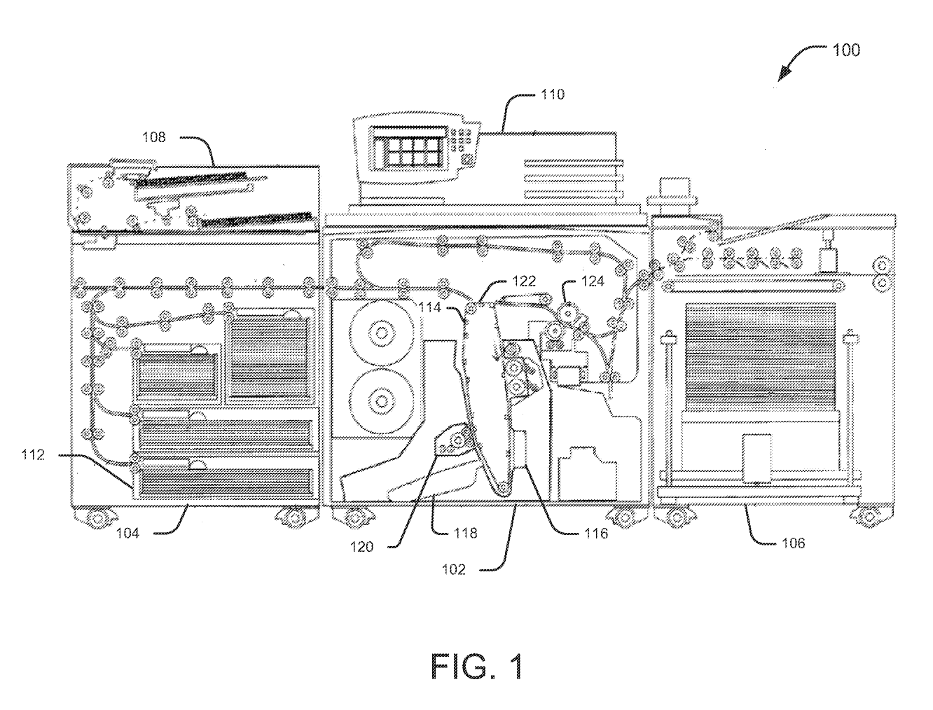

FIG. 1 illustrates an exemplary digital copier printer 100. Although a xerographic, monochrome “laser printer” is shown in FIG. 1, it will be understood that the present description can be applied to any type of digital printing apparatus, such as xerographic, ionographic, or ink-jet, color or monochrome. In general, the digital copier printer 100 includes a printer, copier, scanner, and other known image forming apparatus.

Typically, the printer 100 includes a marking engine 102, a feeding module 104, and a finisher 106. The feeding module 104 stores and dispenses sheets on which images are to be printed, and the marking engine 102 utilizes image signals to create a desired image on the sheets received from the feeding module 104. Subsequently, the finisher 106 handles the prints provided by the marking engine 102 by stacking, folding, stapling, binding, and so on. In case the printer 100 includes a copier device, the printer 100 further includes a document feeder 108 that converts light reflected from original hard-copy image into digital signals, which are in turn processed to create copies with the marking engine 102. Further, a local user interface 110 may control the operations of the printer 100. It should be understood that the printer 100 may be coupled to any number of computers via a network.

The feeding module 104 may include any number of trays 112, each of which stores print sheets (“stock”) of a predetermined type (size, weight, color, coating, transparency, etc.) and includes a feeder to dispense sheets. Certain types of stock may require special handling in order to dispense appropriately. For example, heavier or larger stocks may desirably be drawn from a stack by use of an air knife, fluffer, vacuum grip, or other application (not shown in the FIG. 1) of air pressure toward the top sheet or sheets in a stack. Certain types of coated stock may be drawn from a stack by employing application of heat, such as by a stream of hot air (not shown in the FIG. 1). Sheets drawn from a selected tray 112 are then moved to the marking engine 102 to receive one or more images.

As shown, the marking engine 102 includes a photoreceptor 114, which may be a rotatable belt, also referred to as a rotatable image receptor. Such an image receptor can include, by way of example and not limitation, a photoreceptor, or an intermediate member for retaining one or more ink or toner layers for subsequent transfer to a sheet, such as in a color xerographic, offset, or ink jet printing apparatus. The marking engine 102 is a monochrome xerographic type, although other types of engine, such as color xerographic, ionographic, or ink jet may be used. The photoreceptor 114 is mounted on a number of rollers, and a number of stations, familiar in the art of xerography, are placed suitably around the photoreceptor 114, such as a charging station 116, imaging station 118, development station 120, and transfer station 122. In this embodiment, the imaging station 118 is a laser-based raster output scanner, of a design familiar in the art of laser printing, in which a narrow laser beam scans successive scan lines oriented perpendicular to the process direction of the rotating photoreceptor 114. The laser is turned on and off to selectably discharge small areas on the moving photoreceptor 114 according to image data to yield an electrostatic latent image, which is developed with toner at the development station 120 and transferred to a sheet at the transfer station 122.

A sheet having received an image subsequently passes through a fuser 124, of a general design known in the art, and the heat and pressure from the fuser 124 causes the toner image to become substantially permanent on the sheet. For duplex or two-sided printing, the printed sheet can then be inverted and re-fed to the transfer station 122 to receive a second-side image. The finally printed sheet is then moved to the finisher 106, where it may be collated, stapled, folded, or so on, with other sheets in manners familiar in the art.

There are many possible ways to control the output speed or operating speed, in terms of prints per minute, of the printer 100. The various motors which feed sheets from the trays 112 for printing, copying, or scanning can be readily controlled, whether they are AC, DC, or servo motors, to operate at a desired speed. To this end, the frequency of the motor may be varied depending on the desired output speed, which directly affects the rotational speed of the photoreceptor 114; the rate of data flow operating the laser (or equivalent device) in the imaging station 118 is adjusted as well.

It should be apparent that another technique for controlling the output speed of the printer 100 relates to “pitch configuration,” otherwise known as “pitch spacing,” or “pitch skipping.” An image receptor such as the photoreceptor 114 has an effective imaging area, which can accommodate a certain maximum number of pitches, or spaces for placing images of a certain size thereon. In a typical example in a high-speed, high-volume design, such as shown in the FIG. 1, the photoreceptor 114 can theoretically accommodate six page-size pitches along its circumference. It is, however, also possible to provide for five, four, or three letter-size pitches per rotation, with greater spacing between pitches. Each fewer imaged pitch per rotation of the photoreceptor 114 proportionally decreases the output speed of the printer; four pitches per rotation yield an output speed % that of six pitches per rotation. The number of pitches per rotation of the photoreceptor 114 is ultimately determined by the operation of the imaging station 118 coordinated with the speed of the photoreceptor 114 and the feeding of sheets past the transfer station 122.

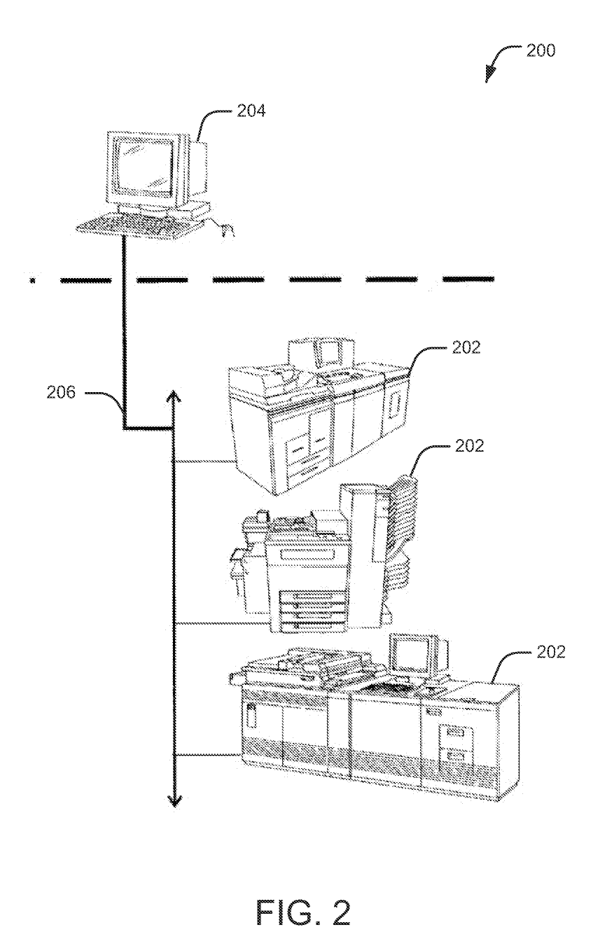

FIG. 2 is a diagram illustrating an exemplary varying operating-speed system 200 that includes a number of image-forming apparatus, such as the printer 100, operated by users. These printing apparatuses are collectively referred to as the printer 100 hereafter. A user working on a computing device, such as a computer 202, may interact with one or more of the printers 100 through a network. A number of users may be coupled to the printers 100 in a shared environment. It should be understood that only one user and three printing devices are illustrated in FIG. 2 for purposes of description.

In an organizational environment, the users who are employees may operate printers not owned by the organization; instead a third party vendor may provide the printers 100 on a billable basis. In such an environment, an accounting module (not shown) may be coupled to each printer 100 maintaining a billing account for each user by counting the number of prints performed within a predetermined time. The accounting module may generate a bill as and when desired, such as on a daily, monthly, or yearly basis. The accounting module may be deployed on each printer 100 or on the third party vendor's computer coupled to each of the printers 100.

Typically, the computer 202 may be installed with a printer driver or similar modules that help operate the printer 100 remotely. While printing, the user may send a printing job to any of the printers 100 through an associated driver. The computer 202 may be installed with one or more drivers to provide a number of facilities to the user such as number of copies, simplex or duplex printing option, type of media sheet, print orientation, and so on. Such an arrangement is well known in the art and will not be discussed in detail here.

The present disclosure provides a strategy for substantially altering the output speed of an image-forming apparatus, such as printer 100. As discussed, given the unusual requirements of some users of high-speed, high-volume printers and copiers, this variability in speed can be exploited to address specific user needs. A user may require high-speed printing for specific jobs. To that end, the user may be provided with a capability of printing different jobs at different speeds based on their criticality or requirement. Such a capability not only provides a flexible operating-speed option but also provides a flexible pricing structure, where a user pays a higher billing rate only for high-speed printing jobs. This promotes economy as the user may not be required to pay for high speed and volume capabilities when he is not using them.

To provide a varying operating-speed system, the driver associated with each printer 100 provides a selectable operating speed option. The operating speed of the printer 100 is configured to the selected speed, ensuring that the job is executed at the desired speed. The speed variation may be accomplished by varying the voltage applied to the motors associated with the printers 100. On selection of the operating speed through the drivers, appropriate signals are transmitted to the motors for varying the voltage as required. High voltage increases the frequency of the motor, which in turn increases the output speed of the printer 100. In general, the pitch spacing between media sheets may also be varied to vary the operating speed. Those skilled in the art, however, will appreciate that the pitch spacing may be maintained at the minimum level to ensure speed increment.

In an embodiment of the present disclosure, the driver may provide two speed options to the users—high speed and low speed, simplifying user's decision-making process. The high speed and the low speed options correspond to operating speeds of about greater than 60 prints per minute and less than 45 prints per minute, respectively. It should be understood that the values corresponding to the high speed and low speed might vary based on the user's requirements. Alternatively, the users may be provided with a set of speed ranges for selection. For example, the drivers may provide a number of options between the speed range from 25 to 90 prints per minute. In another embodiment of the present disclosure, the speed range may be divided into 6 speed options—25 to 35, 35 to 45, 45 to 55, 55 to 65, 65 to 75, and 75 to 85. In this scenario, the user needs to choose an appropriate operating speed for the printer 100. In either of the speed selectable option, the driver provides signals that apply appropriate voltage to the motors for adjusting to the desired operating speed. Each speed option may correspond to a different pricing structure.

In another implementation, the user interface on the printer may present a set of possible speed options for completing the job. For example, while copying when the user is working on a copier device, the user interface on the printer 100 may present a set of possible speed options for copying the documents. The user interface may either specify a low-speed and high-speed option, or provides a list of possible operating speeds or speed ranges. The user interface may include a display screen with buttons, keys, or a touch pad screen to accept the user's preference.

In addition, the printer 100 may allow configuration of the desired operating speed only once the user's personal authentication information is verified. To provide security features to an organization and to establish an appropriate billing system, each user may be provided with personal authentication information, and the users may be required to furnish this information in order to configure the printer 100 to the desired operating speed. This ensures that unauthorized users do not access high operating-speed options. The authentication information may be biometric data such as retina scan, thumb impression, passwords, or other biometric data known in the art. Alternatively, smart cards with user's information may also be swiped to ensure authenticity.

Typically, the printer 100 includes selectable options of quality, quantity, resolution, and so on. The embodiments of the present disclosure may be employed on any printer providing such configuration options, and the user may select more than one configuration options for a particular job. In addition, the selectable speed option provided by the present invention may be compatible with typical media sheets used for office, personal, or production purposes.

In another embodiment of the present disclosure, the system 200 may allow automatic selection of the printer 100 operating speed. To that end, an automation module (not shown) implementing an algorithm may be employed for monitoring a set of parameters to determine a suitable operating speed at any point in time. This automation module may be deployed on each printer 100 or may be utilized by the vendor remotely coupled to each of the printer 100. The algorithm may include parameters such as, but not limited to, job priority, the length of the job queue, predefined time, priority user, or other known parameters that may indicate high-speed requirements. For example, if the length of the job queue goes above a predetermined limit, such as 20 jobs, the algorithm automatically increases the operating speed of the printer 100. The algorithm may vary the operating speed of the printer 100 based on the set predefine time. The user may define the predefine time as a particular time in a day or specific days in a week or month, for example. These set of parameters may be utilized independently or in combination to identify an appropriate operating speed.

As the operating speed of the printer 100 varies the pricing structure associated also changes. To ensure user's acceptance during automatic speed variation, the user may deselect the automatically determined higher speed, and execute the job at a lower speed and consequently, lower price. Alternatively, some users waiting for their job execution may wish to switch to a higher speed suggested by the automatic module, providing greater flexibility in pricing structure selection. The users may deselect the automatically determined speed using the installed driver or through the user interface of the printer 100.

Once an appropriate operating speed for executing a job is identified directly by the users or through the automatic module, the accounting module computes the job execution charges based on the associated billing rate. Each selected speed may correspond to a different billing rate. The user can run the printer 100 at more than two operating speeds, and the user's account can be charged by the vendor at different rates depending on the chosen speed. The operation of each printer 100 is monitored by the vendor. The option of selectively choosing the operating speed of the printer 100 on each job submission provides flexibility to the user to switch speeds based on requirements. Moreover, the users may manage the cost involved in job execution based on requirement.

The speed variation option may be provided to all the users of the printers 100. In another implementation, however, the high-speed capability of the printers 100 may be granted only to a certain set of users. The drivers presenting a variable operating speed option may be installed onto a restricted set of user computers. For example, relatively casual users of the printer 100 sending small jobs from their personal computer will cause the printer 100 to output at usual operating speed. Jobs originating from the set of computers (typically, the computers which generate large reports, or computers associated with predetermined privileged human users) will cause the printer 100 to operate at a higher speed. To determine whether a user is permitted high-speed printing access, user computer identification may be checked against a list of privileged users having high-speed printing access. Alternatively, each user may be required to furnish his identification information, such as by entry of a password. The mechanism for enabling this feature could reside within the printer itself or at the vendor computer.

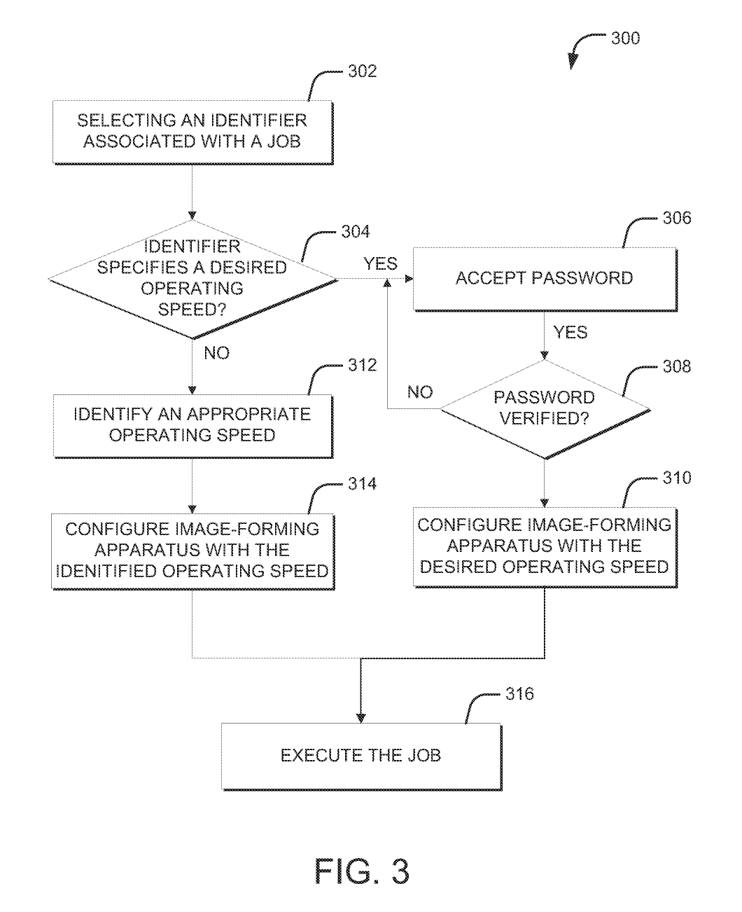

FIG. 3 is a flowchart of an exemplary embodiment of a method 300 for adjusting the operating speed of an image-forming device, such as the printer 100. The method 300 provides a mechanism to vary the pricing structure associated with a printer to suit the requirements of a user.

The method 300 begins at step 302 where a user selects a job for execution on the printer 100 and selects an identifier associated with the job. The identifier may include parameters defining the job or configurations of the printer required to execute the job. For example, the identifier may include, but is not limited to, desired operating speed, quality, quantity, simplex printing, duplex printing, time of execution, and other parameters that may impact the job execution process.

At step 304, the printer 100 identifies whether the identifier indicates an operating speed of the printer 100. In case the identifier includes an indication of the desired operating speed, the printer 100 may be reconfigured. As discussed, while initiating the job, the user may select the operating speed of the printer 100 through a printer driver that is deployed on the user's computer. In general, the printer driver may present two speed options—high speed and low speed. Alternatively, the computer may be installed with as many drivers as the number of possible operating speeds. Subsequently, while sending a job, the user may be presented with a list of possible operating speeds or speed ranges, and the user may select any one of the speeds. Moreover, apart from the drivers, the printer 100 may also provide an interface where the user may be provided with selection options, and the operating speed may be modified.

In case the identifier indicates a desired operating speed, at step 306, the printer 100 accepts authentication information from the user to provide security features. As modifying the operating speed to a higher value may correspond to higher pricing, the authentication process ensures authentic billing for each user. Consequently, at step 308, the printer 100 verifies the authentication information furnished by the user. The authentication details of the interacting users may be stored in a database, and once a user sends a job requiring speed modification, the authentication information provided with the job is compared with the stored authentication detail for verification.

Once the authentication information is verified, the printer 100 is reconfigured with the operating speed specified by the identifier. In case the authentication information is false, the printer 100 prompts the user to provide the information again. In an embodiment of the present disclosure, the printer 100 may accept incorrect authentication information for a predetermined number of times, beyond which the printer 100 may not allow operating speed modification.

Going back to step 304, in case the identifier associated with the job does not specify an operating speed, an appropriate operating speed of the printer 100 may be identified automatically. To that end, a set of parameters may be analyzed to determine an appropriate speed variation. The set of parameters may include job priority, printer's job queue status, predetermined time interval in a day, or other factors that may require faster printing. In an implementation, the method 300 may utilize an algorithm to switch to a higher speed. At step 312, an appropriate operating speed of the printer 100 is identified using the set of parameters. The printer 100 may be configured to analyze the parameters, or a third party vendor providing the printers 100 may use a connected computing device to monitor the set of parameters to modify the operating speed accordingly. Subsequently, at step 314, the printer 100 is configured with the identified operating speed. The configuration of the printer speed discussed at step 310 and 314 involves varying the frequency of the motor attached to the printer 100. Increased frequency results in increasing the sheets passing through the paper path of the printer 100 per minute.

Once the operating speed of the printer is modified at step 310 or 314, the job is executed at step 316 at the desired operating speed. Simultaneously, the vendor maintains a billing account for each user based on the operating speed selected for job execution.

It should be noted that the description below does not set out specific details of manufacture or design of the various components. Those of skill in the art are familiar with such details, and unless departures from those techniques are set out, techniques, designs and materials known in the art should be employed. Those in the art are capable of choosing suitable manufacturing and design details.

The terminology used herein is for the purpose of describing particular embodiments only and is not intended to be limiting of the disclosure. It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for selectively varying the operating speed of an image-forming apparatus, the method comprising:
selecting an identifier associated with a job for execution on the image-forming apparatus;
upon a determination that the identifier specifies a desired operating speed of the image-forming apparatus:
accepting authorization information to vary the operating speed of the image-forming apparatus; and
configuring the image-forming apparatus with the operating speed specified by the identifier upon verification of the authorization information;
upon a determination that the identifier does not specify the desired operating speed:
identifying an appropriate operating speed of the image-forming device for executing the job; and
configuring the image-forming apparatus with the identified operating speed; and
executing the job with the set configuration of the image-forming apparatus.

2. The method of claim 1, wherein the selecting step includes selecting the identifier from a list of identifiers.

3. The method of claim 1, wherein the identifier specifies:
a low operating speed; or
a high operating speed.

4. The method of claim 1, wherein the identifier specifies the operating speed of the image-forming apparatus.

5. The method of claim 1, wherein the identifying step includes automatically identifying the operating speed of the image-forming apparatus based on a set of parameters.

6. The method of claim 5, wherein the set of parameters include:
job priority;
image-forming apparatus job queue status; or
predetermined time.

7. The method of claim 1, wherein the executing step includes computing cost involved in completing the job with the set configuration.

8. A system for selectively varying the operating speed of an image-forming apparatus, the system comprising:
an interface module configured to receive a job and an associated identifier for execution on the image-forming apparatus;
a controller, operatively coupled to the interface module, configured to:
modify the operating speed of the image-forming apparatus by:
identifying a desired operating speed associated with the identifier, including verifying authorization information received along with the identifier; or
determining an appropriate operating speed of the image-forming apparatus; and
execute the job with the set operating speed.

9. The system of claim 8, wherein the interface module is further configured to provide a list of identifiers from which the identifier is selected.

10. The system of claim 8, wherein the controller automatically determines the appropriate operating speed based on a set of parameters.

11. The system of claim 10, wherein the set of parameters include:
job priority;
image-forming apparatus job queue status; or
predetermined time.

12. The system of claim 8, wherein the operating speed is the number of prints per minute.

13. The system of claim 8, wherein the desired operating speed includes:
a low operating speed; or
a high operating speed.

14. The system of claim 8, wherein the authorization information includes:
biometric information; or
passwords.

15. The system of claim 8 further comprising a pricing module configured to compute the cost of executing the job based on the operating speed.
